(19) United States
(12) Patent Application Publication
(10) Pub. No.: US 2006/0155389 A1
(43) Pub. Date: Jul. 13, 2006

(54) Method of controlling an electronic device

(76) Inventors: Francesco Pessolano, Eindhoven (NL); Mauro Barbieri, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/562,541

(22) PCT Filed: Jun. 30, 2003
(86) PCT No.: PCT/IB04/51053

§ 371 Date: Dec. 28, 2005

(30) Foreign Application Priority Data
Jul. 3, 2003 (EP) 03101997.9

(51) Int. Cl. G05B 11/01

(52) U.S. Cl. 700/12; 700/13; 700/19

(57) ABSTRACT

The method of the invention detects (1) a state of a user, determines (3) whether, based on this state, the user is asleep, and switches (5) the electronic device to a mode of reduced power consumption when it has been determined that the user is asleep. The computer program of the invention enables a programmable device to carry out the method. The electronic device of the invention comprises at least a control unit and a receiver for receiving, from a detector, a detection signal comprising a state of a user. The control unit is able to determine whether, based on his state, the user is asleep and switches the electronic device to a mode of reduced power consumption when it has been determined that the user is asleep.

The invention relates to a method of controlling an electronic device and in particular to a method comprising the step of switching the electronic device to a mode of reduced power consumption.

The invention further relates to a computer program enabling a programmable device to carry out a method of controlling an electronic device.

The invention also relates to an electronic device and in particular to an electronic device comprising a control unit which is able to switch the electronic device to a mode of reduced power consumption.

This method is used in, for example, TVs having a timer function. A user of such a TV can specify a period of time, after which the TV automatically switches to a standby mode. In the standby mode, a TV generally consumes less power than in the viewing mode. A drawback of the timer function is its inefficiency. It often happens that the user has stopped watching TV more than 5 minutes before the TV switches to a standby mode.

It is a first object of the invention to provide a method of the type described in the opening paragraph, which allows a further reduction of power consumption.

It is a second object of the invention to provide an electronic device of the type described in the opening paragraph, which is able to further reduce the power consumption.

According to the invention, the first object is realized in that the method comprises the steps of: detecting a state of a user; determining whether, based on this state, the user is asleep; and switching the electronic device to a mode of reduced power consumption when it has been determined that the user is asleep. Advantageously, this method allows the electronic device to reduce power when a user is asleep. The user will generally not mind when, for example, a radio or TV stops generating output, i.e. sound and/or video, when he is asleep. If there is a plurality of users simultaneously using one electronic device, the method may detect a state of one of the plurality of users, a plurality of states of the plurality of users, or a combined state of the plurality of users. The electronic device may be switched to, for example, a mode of reduced power consumption when it has been determined that all of the plurality of users are asleep.

As an additional advantage, the method according to the invention reduces the chance that the electronic device wakes up the user.

In an embodiment of the method of the invention, the step of detecting a state of a user comprises measuring his brainwaves. Brainwaves may be measured, for example, by using a suitable detector connected so as to have a neutral point, e.g. the earlobe, and a measurement point, i.e. any point in contact with the brain. For brainwave measurement, direct contact with the user is not absolutely necessary: remote brainwave measurement is also possible.

The step of detecting a state of a user may comprise detecting his movement. An infrared sensor, which is able to detect changes in background temperature, or an accelerometer, may be used, for example, to detect movement.

The step of determining whether the user is asleep may comprise determining whether his movement has been detected for a predetermined period of time. If the user has not moved for a longer time, it is very likely that he is asleep.

The method may further comprise the step of adapting output generated by the electronic device on the basis of the state of the user. If it is likely, but not certain, that a user is asleep, the output may advantageously be adapted. This feature may not only be used to reduce power consumption, but also to verify whether a user is asleep. Output may be adapted, for example, after a predetermined period of time in which no movement has been detected and in such a way that a user will notice if he is not asleep. He may automatically or purposely move upon noticing the adaptation, thereby triggering a change of the detected state.

The step of adapting output generated by the electronic device may comprise at least one of: reducing volume of sound output by the electronic device, reducing quality of sound output by the electronic device, reducing size of image output by the electronic device, and reducing quality of image output by the electronic device. These measures generally reduce power consumption and are likely to be noticed by the user.

According to the invention, the second object is realized in that the electronic device comprises: a receiver for receiving, from a detector, a detection signal comprising a state of a user; and a control unit which is able to use the receiver to receive the detection signal from the detector, determine whether, based on his state, the user is asleep, and switch the electronic device to a mode of reduced power consumption when it has been determined that the user is asleep.

As an additional advantage, the electronic device according to the invention reduces the chance that the electronic device wakes up the user.

An embodiment of the electronic device of the invention further comprises an output means which is able to generate an output signal, and the control unit is able to adapt the output signal on the basis of the state of the user.

The electronic device may further comprise a motion detector. This embodiment is advantageous, for example, for televisions and wearable electronics. A television may comprise, for example, an infrared sensor and a wearable electronic device, e.g. a portable MP3 player, may comprise, for example, an accelerometer.

These and other aspects of the method and electronic device of the invention will be further elucidated and described with reference to the drawings, in which:

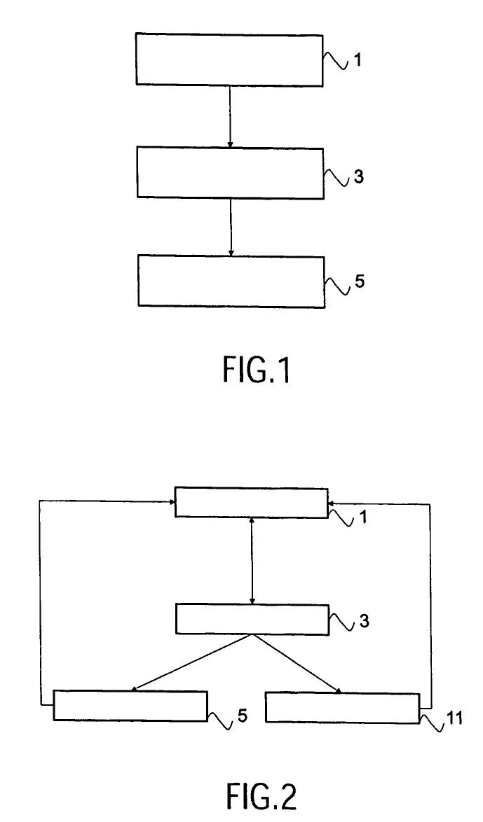

FIG. 1 is a flow diagram of the method of the invention;

FIG. 2 is a flow diagram of an embodiment of the method;

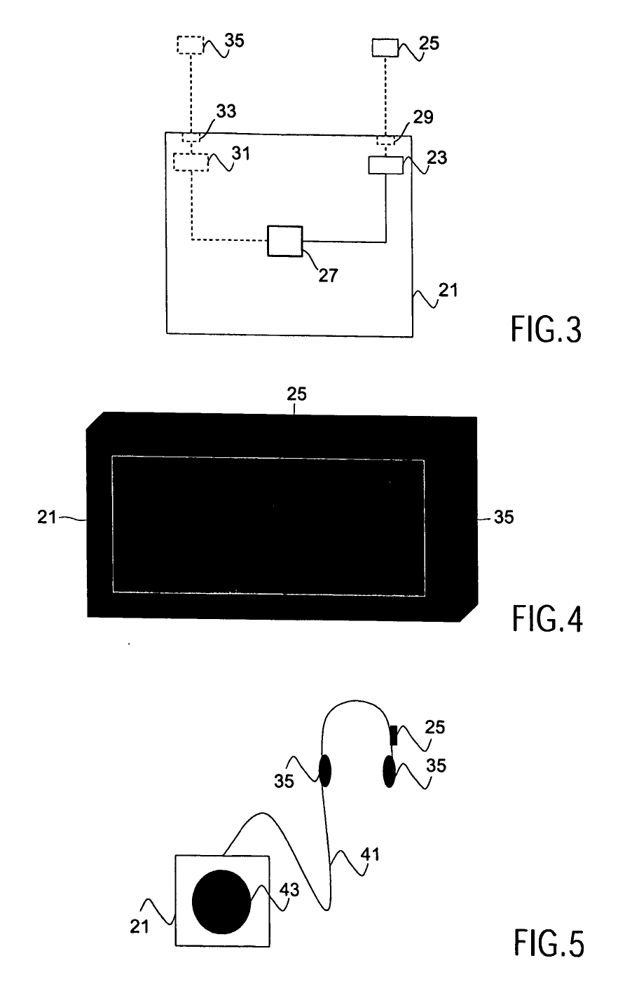

FIG. 3 is a block diagram of the electronic device of the invention;

FIG. 4 is a schematic representation of a first embodiment of the electronic device; and

FIG. 5 is a schematic representation of a second embodiment of the electronic device.

Corresponding elements within the drawings are identified by the same reference numerals.

The method of the invention, see FIG. 1, comprises three steps. Step 1 detects a state of a user. Step 3 determines whether, based on this state, the user is asleep. Step 5 switches the electronic device to a mode of reduced power consumption when it has been determined that the user is asleep.

Step 1 may comprise measuring brainwaves of the user and/or detecting his movement. The basic phases of sleep, by convention, are divided into two main types: REM (Rapid Eye Movement, or dreaming) and Non-REM (NREM). NREM is generally broken up into four phases. In each phase, brainwaves become progressively larger and slower, and sleep becomes deeper. After reaching phase 4, the deepest period, the pattern reverses, and sleep becomes progressively lighter until REM sleep, the most active period occurs. Each of these five phases is characterized by a wave pattern that is easy to identify:

1. Beta waves (very low amplitude, high frequency; 13 to 30 waves/sec): A person is awake and active (in a state of alertness). They are the fastest waves and signal an active cortex and an intense state of attention.

2. Alpha waves (low amplitude, 8 to 13 waves/sec): A person is awake and relaxed, with closed eyes.

3. Theta waves (low-medium amplitude, spike-like waves; 3 to 7 waves/sec): A person is sleepy, already sleeping, or in a sleep transition.

4. Delta waves (high amplitude, low frequency; 3 waves/sec): A person is in a deep sleep.

5. REM (60 to 70 waves/sec): Deep active sleep.

By means of measuring brainwaves it is possible to identify the state of a person as being awake or in a given sleeping phase.

An embodiment of the method is shown in FIG. 2. Step 1 detects a state of a user. Step 3 determines whether, based on this state, the user is asleep. Step 5 switches the electronic device to a mode of reduced power consumption when it has been determined that the user is asleep. Step 3 may comprise determining whether movement of the user has been detected for a predetermined period of time (X). If no movement has been detected for a predetermined period of time or a certain brainwave pattern is identified, e.g. delta waves or REM, step 3 may determine that the user is asleep. If step 3 determines that the user is asleep, step 5 will be executed next. If movement was detected a few seconds before step 3, it is most unlikely that the user is asleep. If beta waves and possibly alpha waves are being detected, the user is certainly not asleep. If step 3 determines that it is most unlikely that the user is asleep or is certainly not asleep, step 1 will be executed next.

After step 5, step 1 may be executed next. Whether step 1 will be executed after step 5 may depend on the identified brainwave pattern or the period of time during which no movement has been detected. If delta waves are being detected or no movement has been detected during a period X1, the electronic device may enter, for example, a hibernation mode, in which a resumption is still possible. If REM sleep is being detected or no movement has been detected during a period X2 (X2>X1), the electronic device may, for example, switch off completely. In another embodiment, the electronic device may always switch off completely in step 5, and step 1 may never be executed after step 5.

If no movement has been detected for a predetermined period of time (Y, Y<X), step 3 may determine that the user is probably asleep and step 11 will be executed next. In another embodiment, this determination could be made in a separate step. Step 11 adapts output generated by the electronic device on the basis of the state of the user. Step 11 may comprise reducing volume of sound output by the electronic device, reducing quality of sound output by the electronic device, reducing size of image output by the electronic device, and/or reducing quality of image output by the electronic device. Step 11 may also be executed if alpha waves or theta waves are being detected in step 3. The way in which the output is adapted may depend on the identified brainwave pattern. After step 11, step 1 will be executed next.

The electronic device 21 of the invention, see FIG. 3, comprises a receiver 23 and a control unit 27. The receiver 23 is able to receive, from a detector 25, a detection signal comprising a state of a user. The detector 25 may be located in the electronic device 21, attached to the electronic device 21, or located outside the electronic device 21. If the detector 25 is a motion detector located outside the electronic device 21, it may be located, for example, somewhere in a living room or a bedroom. The detector 25 may also be a pressure sensor, for example, incorporated into a shoe, a bed, or a pillow, which can detect movement by sensing a change of pressure. The electronic device 21 may be, for example, a TV, a set-top box, a digital video player, a receiver, an amplifier, a portable CD player, a portable MP3 player, or a portable video player.

The detector 25 may be connected to an input interface 29 of the electronic device 21 via a wire. The input interface 29 may be connected to the receiver 23. The control unit 27 is able to use the receiver 23 to receive the detection signal from the detector 25, determine whether, based on his state, the user is asleep, and switch the electronic device 21 to a mode of reduced power consumption when it has been determined that the user is asleep. The electronic device 21 may further comprise an output means 31 which is able to generate an output signal. The control unit 27 may control the output means 31. The control unit 27 may be able to adapt the output signal on the basis of the state of the user. The output means 31 may be connected to an output interface 33. The output interface 33 may be connected to a reproduction means 35. The reproduction means 35 may be, for example, a TV, a display, an amplifier, a speaker, or an earphone. The output means 31 may be, for example, a signal converter. The reproduction means 35 and the output means 31 may be implemented in the same hardware component. The control unit 27 and the output means 31 may be implemented in the same hardware component.

A first embodiment of the electronic device 21 is shown in FIG. 4. The electronic device 21 comprises a receiver 23 and a control unit 27, as shown in FIG. 3. In this embodiment, the electronic device 21 is a television. The television comprises the detector 25 and a reproduction means 35. In this embodiment, the detector 25 is a motion detector, e.g. an infrared sensor or a digital video camera, and the reproduction means 35 is a display. The reproduction means 35 is coupled to an output means 31, as shown in FIG. 3.

A second embodiment of the electronic device 21 is shown in FIG. 5. The electronic device 21 comprises a receiver 23 and a control unit 27, as shown in FIG. 3. In this embodiment, the electronic device 21 is a portable CD player coupled to a reproduction means 35. The portable CD player comprises a CD reader 43. In this embodiment, the reproduction means 35 is a headphone, i.e. a pair of earphones. The reproduction means 35 is coupled to an output means 31, as shown in FIG. 3. The reproduction means 35 and the electronic device 21 are connected via a wire 41. The reproduction means 35 comprises a detector 25. The detector 25 may be, for example, an accelerometer or a brainwave measurement module and may be located anywhere in or on the headphone.

While the invention has been described in connection with preferred embodiments, it will be understood that modifications thereof within the principles outlined above will be evident to those skilled in the art, and thus the invention is not limited to the preferred embodiments but is intended to encompass such modifications. The invention resides in each and every novel characteristic feature and each and every combination of characteristic features. Reference numerals in the claims do not limit their protective scope. Use of the verb “to comprise” and its conjugations does not exclude the presence of elements or steps other than those stated in the claims. Use of the article “a” or “an” preceding an element or step does not exclude the presence of a plurality of such elements or steps.

As will be apparent to a person skilled in the art, ‘means’ are understood to include any hardware (such as separate or integrated circuits or electronic elements) or software (such as programs or parts of programs) which perform in operation or are designed to perform a specified function, be it solely or in conjunction with other functions, be it in isolation or in co-operation with other elements. The invention can be implemented by means of hardware comprising several distinct elements, and by means of a suitably programmed computer. In the device claim enumerating several means, several of these means can be embodied by one and the same item of hardware. ‘Computer program’ is to be understood to mean any software product stored on a computer-readable medium, such as a floppy disk, downloadable via a network, such as the Internet, or marketable in any other manner.

1. A method of controlling an electronic device, comprising the steps of:
detecting (1) a state of a user;
determining (3) whether, based on this state, the user is asleep; and
switching (5) the electronic device to a mode of reduced power consumption when it has been determined that the user is asleep.

2. A method as claimed in claim 1, characterized in that the step of detecting (1) a state of a user comprises measuring his brainwaves.

3. A method as claimed in claim 1, characterized in that the step of detecting (1) a state of a user comprises detecting his movement.

4. A method as claimed in claim 3, characterized in that the step of determining (3) whether the user is asleep comprises determining whether his movement has been detected for a predetermined period of time.

5. A method as claimed in claim 1, characterized in that it further comprises the step of adapting (11) output generated by the electronic device on the basis of the state of the user.

6. A method as claimed in claim 5, characterized in that the step of adapting (11) output generated by the electronic device comprises at least one of: reducing volume of sound output by the electronic device, reducing quality of sound output by the electronic device, reducing size of image output by the electronic device, and reducing quality of image output by the electronic device.

7. A computer program enabling a programmable device to carry out a method as claimed in claim 1.

8. An electronic device (21), comprising:
a receiver (23) for receiving, from a detector (25), a detection signal comprising a state of a user; and
a control unit (27) which is able to use the receiver (23) to receive the detection signal from the detector (25), determine whether, based on his state, the user is asleep, and switch the electronic device (21) to a mode of reduced power consumption when it has been determined that the user is asleep.

9. An electronic device (21) as claimed in claim 8, characterized in that it further comprises:
an output means (31) which is able to generate an output signal; and
the control unit (27) is able to adapt the output signal on the basis of the state of the user.

10. An electronic device (21) as claimed in claim 8, characterized in that it further comprises a motion detector.
